(19) United States
(12) Patent Application Publication
(10) Pub. No.: US 2025/0212884 A1
(43) Pub. Date: Jul. 3, 2025

(54) Magnesia Compounds For Preventing Contamination Of Animal Farming Facilities And For Decontamination Of Same

(71) Applicant: BROMINE COMPOUNDS LTD., Beer-Sheva (IL)

(72) Inventors: Mohammed ABUELHAIGA, Kibbutz Mefalsim (IL); Reuven ROZEN, Beer Sheva (IL); Nikolay FUX, Beer Sheva (IL); Alexander FRENKLACH, Lehavim (IL); Debora Fumie TAKAHASHI, Osasco SP (BR); Reut ISRAELI, Meitar (IL)

(21) Appl. No.: 18/850,620

(22) PCT Filed: Apr. 4, 2023
(86) PCT No.: PCT/IL2023/050361

§ 371 Date: Sep. 25, 2024

Related U.S. Application Data
(60) Provisional application No. 63/328,285, filed on Apr. 7, 2022.

(51) Int. Cl. A01N 59/06; A01P 1/00

(52) U.S. Cl. CPC A01N 59/06; A01P 1/00

(57) ABSTRACT

The present invention relates to magnesia compounds (MgO) provided as powder or in aqueous dispersions for controlling and/or preventing microbial contaminations in surfaces located in animal farms. in particular for controlling and/or preventing microbial contaminations in intensive animal farming.

### FIELD OF THE INVENTION

The present invention relates to magnesia compounds (magnesium oxide, MgO) provided as powder or in aqueous dispersions, for controlling and/or preventing microbial contamination in animal farming, in particular for controlling bacteria, fungi and viruses in intensive production animal farms.

### BACKGROUND OF THE INVENTION

Farming of domesticated animals raised to produce commodities, such as food products, and in particular intensive farming, is associated with hazards related to the environment and to exposure to contaminating agents, such as viruses, bacteria, parasites, fungi and dust. These risks directly affect animal health, growth and mortality rate. Exposure to the above and other risks leads to economic consequences and to a potential health risk for consumers, both of great concern.

For example, many pathogens are associated with poultry diseases, in particular various Salmonella species (Salmonella Spp.), which can be detrimental for the health of the poultry and human consumers. The pathogens are spread by the poultry carriers and flourish on organic matter such as manure, carcasses of the animals and surfaces. In addition, non-uniform cracked surfaces are a fertile ground for pathogenic growth.

Therefore, measures are taken for cleaning and disinfecting animal facilities, for reducing the above risks. These measures include multiple steps, inter alia a preliminary cleaning step which is crucial for removal of organic material that reduces the effectivity of disinfecting agents and constitute a basis for pathogen growth, careful drying, sealing of cracks and disinfection.

Currently available disinfecting agents are based on chemicals known as biocides, the most abundant of which are phenols, quaternary ammonium salts, aldehydes (mostly in combination with quaternary ammonium salts, e.g., Glutamon), halogens, oxidizers, alcohols, etc. However, these agents suffer from several disadvantages, such as being toxic, irritant, or corrosive, thus posing serious health and safety hazards as well as environmental concerns. Furthermore, the currently available disinfectant agents generally do not have any residual effect and therefore microorganism entry into the farm environment after the disinfection process results in recontamination.

For example, agents based on release of active chlorine are neutralized by exposure to strong sun light, residual organic material in the disinfecting area and by mineral load in water. In addition, the area disinfected by agents based on release of active chlorine must be carefully washed after the disinfection procedure, negatively affecting the long-term effect thereof.

Patent publication CN101343133 relates to a method of purifying wastewater of livestock and poultry, comprising various disinfecting steps, including anaerobic digestion. At the final step, prior to discharging the water, magnesium oxide is added in order to generate magnesium ammonium phosphate precipitates. In addition, patent publication KR1020090038162 relates to a method for eliminating bacteria at poultry farms comprising several metal oxides and various other agents. Furthermore, Stalosan F is a multifunctional biocide based on phosphates, Ca-, and Fe-sulphates, Perica oil and Al-silicates, showing effects on animal health and the environment when scattered as a powder on surfaces in animal houses (Lyasota, V. & Sokolova, L. 2018. Disinfectants, modern characteristics and safety of use in animal husbandry. Naukovij vìsnik veterinarnoï medicini. 87-99. 10.33245/2310-4902-2018-144-2-87-99). Antimicrobial coatings and films made of nano-crystalline cellulose into which magnesium oxide or hydroxide is incorporated were reported in patent publication WO 2019/026071.

### SUMMARY OF THE INVENTION

It has been unexpectedly shown by the inventors that application of a sprayable dispersion comprising MgO in farmhouses control contamination by Salmonella species, as evidenced, for example, by the reduction of Salmonella concentration below the detection limit shown in the Examples below. Furthermore, magnesia dispersions may be effective against other pathogens common with poultry farming as evidenced by the virus inactivation effect on hosts cells and eggs infected by various viral species and may be thus used for the control of additional pathogens, for example avian Influenza, Norovirus, as well as Escherichia coli, bacteria of the genus Enterobacter, Pseudomonas aeruginosa, and fungi species of the genus Aspergillus or Penicilium.

In addition, upon culturing the sub-species Salmonella typhimurium in the presence of dispersions comprising different magnesium compounds, namely magnesium oxide, magnesium hydroxide and basic magnesium carbonate, superiority in preventing the growth of S. typhimurium was demonstrated in assays conducted with magnesium oxide.

The disinfecting procedure of animal farming facilities, e.g., poultry facilities and other equipment for management thereof must ensure complete coverage of all surfaces, such that all of the surfaces in the facility and other equipment are properly treated. Acceptable application methods for complete surface coverage by sprayable dispersions include spraying, e.g., using a motorized suspension sprayer mounted on a small electric vehicle, fogging, or the like. Application methods for complete surface coverage by magnesia powder include uniform spreading of the powder by known methods. It has been shown that dispersions comprising magnesia compounds form homogenous and uniform coatings on the surface onto which they are applied, for example when applied by spraying on vertical or horizontal surfaces, while filling cracks, crevices and kinks which often enable breeding of harmful microorganisms.

Furthermore, while the currently available disinfectants are toxic, irritant and/or non-degradable, and in many cases necessitate an additional rinsing step after completing the disinfecting step in order to remove residual hazardous disinfectants, magnesia compounds (namely MgO having various characteristics, e.g., as detailed herein below), as a powder or in a dispersion, are advantageous, as they do not pose a threat to humans or animals (e.g., poultry) and therefore there is no requirement to eliminate residues thereof from animal facilities after application. Furthermore, magnesia compounds are advantageous as they are stable in the presence of organic material, are safe to apply and generally do not harm the surfaces onto which they are applied and further provide a residual effect during the entire period of animal growth in the farm.

Therefore, by one of the aspects thereof, the present disclosure provides a method for preventing microorganism contamination of a surface, or decontaminating a surface, comprising applying magnesia (MgO) onto said surface, wherein the surface is located in facilities and on equipment for management of animals raised for food, such as animals raised in intensive animal farming, for growing poultry and livestock. By way of example, the surface as herein defined is located in an animal farming facility, a vehicle or a vessel used for transporting the animals and may be ground, concrete, metal or wood surface.

In some embodiments, the magnesia is applied in the form of an aqueous dispersion according to the present invention, which optionally comprises at least one suspension aid.

In particular, the magnesia compound (MgO) as herein defined is characterized by having a particle size distribution with d₁₀ ranging from 0.5 μm to 1.5 μm, d₅₀ ranging from 1.5 μm to 6.0 ƒm and d₉₀ ranging from 5.0 μm to 45.0 μm, wherein said magnesia compound is further characterized by having:
a) a surface area ranging from 5.0 to 25.0 m²/gr,
b) a citric acid activity (CAA 40) ranging from 25 to 300 seconds,
c) a loss on ignition (LOI) ranging from 0.1% to 8.0% by weight, and
d) a bulk density ranging from 0.25 to 0.60 gr/ml.

The aqueous dispersion as herein defined comprises MgO at not less than 5% by weight based on the total weight of the aqueous dispersion. In some embodiments, the aqueous dispersion as herein defined is sprayed onto said surface at time periods where the animals are not in the treated space, subsequent to cleaning the surface.

In some embodiments, the method according to the present disclosure is suitable to poultry, and the surface is located in a poultry farming facility, a vehicle or a vessel used for transporting the poultry.

The method as herein defined is particularly applicable to preventing contamination of a surface by a bacterial microorganism, such as Salmonella spp, or by a viral microorganism, such as an avian virus, e.g., avian influenza virus or Norovirus.

The present disclosure further provides a method for preventing Salmonella spp. contamination of a surface located in a poultry farming facility, a vehicle or a vessel used for transporting the poultry, or decontaminating said surface, comprising applying an aqueous dispersion comprising MgO at not less than 5% by weight based on the total weight of the aqueous dispersion, wherein said aqueous dispersion optionally comprises at least one suspension aid.

### DETAILED DESCRIPTION OF THE INVENTION

The present disclosure relates to use of magnesia compounds (MgO) or dispersions comprising the same. In particular, the present disclosure relates to a method for preventing microorganism contamination of a surface, or decontaminating a surface, comprising applying magnesia (MgO) onto said surface. The surface as herein defined is located in facilities and on equipment for management of animals raised for food, e.g., animals raised by intensive farming. The magnesia may be applied in the form of an aqueous dispersion which optionally comprises at least one suspension aid.

In its most general form, preparation of magnesium oxide is based on calcination of magnesium hydroxide. The temperature profile in the calcination kiln influences the properties and activity of the resultant magnesium oxide. In the Aman process, magnesium oxide is first formed by the decomposition of hydrated magnesium chloride; subsequent washing results in hydration, i.e., hydroxide formation, which is then calcined back to give the oxide in a pure form. Another industrial approach is based on precipitation of magnesium hydroxide from brine by addition of an alkaline agent, e.g., calcium hydroxide, sodium hydroxide or ammonium hydroxide, and then calcination to produce the oxide.

Grades of magnesium oxide suitable for use in the invention are selected to satisfy a set of criteria, e.g.:
particle size distribution (PSD) characterized by d₁₀, d₅₀, and d₉₀ values such that d₁₀≤1.5 μm (e.g. from 0.1 to 1.5 μm, from 0.5 to 1.5 μm, from 0.5 to 1.0 μm or from 0.8 to 1.3 μm), 1.5 μm≤d₅₀≤6.0 μm (e.g. from 1.5 to 5.0 μm) and 5.0 μm≤d₉₀≤45.0 μm, for example 8.0 μm≤d₉₀≤45.0 μm or 5.0 μm≤d₉₀≤30 μm (measured by laser diffraction).
specific surface area above 3.0 m²/gr, preferably from 5.0 to 25.0 m²/gr, more preferably from 5.0 to 15.0 m²/gr, more preferably from 5.0 to 10 m²/gr or from 5.0 to 9 m²/gr (measured by the BET method).
Citric acid activity (CAA 40) ranging from 25 to 300 seconds, preferably from 80 to 200 seconds, e.g. from 150 to 200 seconds.
Loss on ignition (LOI, a measure of residual content of magnesium hydroxide) in the range of 0.1 to 8.0% by weight, e.g., from 4.0 to 8.0%, preferably from 0.2 to 3.0% or from 0.2 to 1.0% by weight.
Bulk density in the range of 0.25 to 0.60 gr/ml, for example between 0.30 and 0.40 gr/ml or from 0.25 to 0.35 gr/ml.

Grades meeting the properties set for the above are available on the marketplace (e.g., ICL-IP). An illustrative preparation of MgO for use in the invention is based on milling (dry milling) of MgO product obtained by calcination of magnesium hydroxide at temperature in the range of 600 to 950° C. Alternatively, preparation of MgO for use in the framework of the invention may be based on wet milling of magnesium hydroxide before the calcination step mentioned above.

In particular, the Examples shown below were conducted with MgO prepared as described in Preparation 1 below. Thus, the dispersion of the present disclosure may be prepared using MgO characterized by having a particle size distribution with d₁₀ ranging from 0.5 to 1.5 μm, by a d₅₀ ranging from 1.5 to 6.0 μm and by a d₉₀ ranging from 5.0 to 45 μm, a surface area ranging from 5.0 to 25.0 m²/gr, LOI ranging from 0.2 to 5.0 wt %, bulk density ranging from 0.30 to 0.50 gr/ml and by citric acid activity (40) ranging from 80 to 200 seconds.

The dispersion/suspension of the present disclosure may be also prepared using other grades of MgO, for example such grade which is characterized by having a particle size distribution with d₁₀ ranging from 0.8 to 1.5 μm, by a d₅₀ ranging from 2.5 to 6.0 μm and by a d₉₀ ranging from 10.0 to 45 μm, a surface area ranging from 5.0 to 15.0 m²/gr, LOI ranging from 2.0 to 8.0 wt %, bulk density ranging from 0.25 to 0.35 gr/ml and by citric acid activity (40) ranging from 100 to 200 seconds.

The dispersion/suspension of the present disclosure may be further prepared using an MgO grade which is characterized by having a particle size distribution with d₁₀ ranging from 1.0 to 1.5 μm, by a d₅₀ ranging from 2.5 to 6.0 μm and by a d₉₀ ranging from 10.0 to 45.0 μm, a surface area ranging from 5.0 to 10.0 m²/gr, LOI ranging from 0.2 to 6.0 wt %, bulk density ranging from 0.3 to 0.5 gr/ml and by citric acid activity (40) ranging from 100 to 200 seconds.

The physical properties of magnesium oxide can be determined based on methods well known in the art, for example as detailed herein.

To prepare an aqueous suspension/dispersion of MgO, powder of the relevant magnesium oxide compounds is mixed with water, optionally in the presence of one or more suspension aid(s), for example dispersant(s), with the aid of a dissolver stirrer/disperser operating at 5,000 to 10,000 revolutions per minute (rpm), on a laboratory scale (e.g., using high shear mixing instrument). The aqueous suspension/dispersion as herein defined may further comprise customary additives.

Optionally, commercially available biocides (e.g., phenols, aldehydes, etc.) may be used in conjunction with the dispersion(s)/suspension(s) as herein defined.

A stable suspension/dispersion of MgO in water is formed with magnesia compound(s) content of not less than 5%, e.g., from 5 to 40%, from 5 to 35%, from 5 to 30%, from 5 to 25%, from 5 to 20%, from 7.5 to 25%, preferably from 10 to 20% by weight based on the total weight of the magnesium compound(s) suspension/dispersion. In particular, the present disclosure relates to an aqueous dispersion comprising MgO at not less than 5% by weight based on the total weight of the aqueous dispersion, e.g., from 5 to 20%, for example, 5, 6, 7, 8, 9, 10, 11, 12, 13, 14, 15, 16, 17, 18, 19 or 20%, by weight based on the total weight of the magnesium compound(s) suspension/dispersion.

In further embodiments the aqueous dispersion comprises MgO at not less than 10% by weight based on the total weight of the aqueous dispersion, e.g., from 10 to 20%, for example, 10, 11, 12, 13, 14, 15, 16, 17, 18, 19 or 20%, by weight based on the total weight of the magnesium compound(s) suspension/dispersion.

When present, the concentration of the suspension aid (e.g., dispersant) is not less than 0.5%, e.g., not less than 1%, for example from 0.5 to 10.0%, from 1 to 10.0%, from 1 to 8.0%, preferably from 1 to 5%, particularly 2.5% by weight based on the total weight of solid magnesia compound(s) (e.g., MgO) in the suspension/dispersion.

Accordingly, a preferred aqueous suspension/dispersion of the invention comprises (percentage by weight based on the total weight of the aqueous dispersion):
from 50 to 95% by weight of water, e.g., 70 to 94% or 75 to 80%.
from 5 to 40% by weight of magnesia compounds (MgO), e.g., from 5 to 25%,
from 5 to 20%, or from 10 to 25%, for example from 10 to 20%; and optionally
from 0.25 to 10% by weight, e.g., 0.25 to 5%, for example 0.25% or 0.5% of a suspension aid (e.g., a dispersant).

It should be understood that the term “aqueous dispersion” (used interchangeably with “aqueous suspension”) for the purpose of the present disclosure means the dispersion of solids (powders) and additives described herein in an aqueous carrier. The aqueous dispersion is usually characterized by a concentration of solids ranging, for example, from 5% by weight to 40% by weight of the total weight of the aqueous dispersion/suspension. The solid content includes all the components of the dispersion except for the aqueous carrier, such as the magnesia compounds (MgO) powder, the suspension aid (dispersant) powder (e.g., sodium pyrophosphate, when present), etc.

Addition of a suspension aid (e.g. a dispersant), was previously found by the inventors to improve dispersion of the magnesium compounds, resulting in a suspension with improved anti-settling properties and minor precipitation. Therefore, the present invention further provides an aqueous dispersion comprising magnesia compounds (MgO having various characteristics) and optionally at least one suspension aid for imparting anti-microbial (e.g., anti-bacterial) properties to a surface susceptible to contamination by microorganisms in intensive animal farms.

The suspension aid (e.g., dispersant) suitable for use in accordance with the present invention may be any inorganic dispersant, e.g., water soluble phosphate/pyrophosphate/polyphosphate salt, for example but not limited to commercially available pyrophosphate dispersant, mono ammonium phosphate (also termed herein MAP), ammonium phosphate or ammonium polyphosphate. Other approaches to stabilize the suspension and minimize settling include the use of xanthan gum, as described in U.S. Pat. No. 4,834,957, or other conventional suspension aids based on cellulose derivatives (e.g., carboxymethyl cellulose).

The dispersion according to the present disclosure comprising magnesia compounds, for example, MgO and at least one suspension aid (dispersant) may be prepared by first separately formulating or dispersing each one of the magnesia components and the suspension aid (dispersant) or by co-dispersing both. The weight ratio of the magnesia compounds to the dispersant in the co-formulation is, for example, in the range of 50:1 to 3:1, e.g., from 25:1 to 3:1, e.g., from 10:1 to 4:1.

Application of MgO onto the surface of the present disclosure can be performed by dispersing, placing or contacting the magnesia powder or the dispersion comprising the same using any method known in the art, manually or mechanically. The choice of application method(s) for complete surface coverage depends on the nature of the material being applied, namely, powder or dispersion/suspension comprising thereof. Application methods include (but are not limited to) spreading, pouring, spraying (horizontally and/or vertically), or fogging (aerosols), namely the release of a disinfecting agent to the air in the form of miniature droplets.

The present disclosure in particular relates to a method for preventing microorganism contamination of a surface, or decontaminating a surface, comprising applying by spraying an aqueous dispersion comprising MgO onto said surface as herein defined, wherein the aqueous dispersion optionally comprises at least one suspension aid. Spraying of a dispersion comprising magnesia may be performed by loading the dispersion as herein defined into a delivery vessel and setting the amount to be pumped onto a surface. The vessel may be a manually operated pump that forces the dispersion in the container to a nozzle, from which it emerges. Additionally, or alternatively, the vessel may be a pressurized pump sprayer, which pressurize the container and release the disinfectant when the spray nozzle is opened or an electrical pump sprayer that mediates the variation in the flow by using an electric motor to automatically draw the disinfectant and deliver a constant volume to the spray nozzle. In particular, the vessel may be a pressurized pump sprayer carried by a spraying car.

A further application method is fogging of a dispersion comprising magnesia compounds, creating and dispersing an aerosol in order to apply the dispersion to target surfaces that may be difficult to reach (such as roofs). It is achieved using either a static, purpose-built system or a mobile unit. Fogging saturates the target atmosphere with a fog of the dispersion as herein defined with a built-in system or mobile units. Fogging is carried out for at least 15-30 minutes to enable the fog to disperse. After fogging, an additional period of about 45-60 minutes is required to allow the droplets to settle out of the air and onto the surfaces.

When applied by spraying onto surfaces, the aqueous dispersion/suspension comprising MgO and optionally a suspension aid according to the present disclosure is particularly advantageous, as the dispersions settle onto the surfaces being treated, including any crevices and cracks thereof, and is essentially not volatile, thus lowering the risk that may be associated with spreading volatile disinfectants. Notwithstanding the above, the MgO particles are easily removed from the surfaces by mechanical means, e.g., by cleaning as detailed herein below.

For example, applying magnesia (MgO) onto said surface is performed by spraying a dispersion comprising magnesia compounds onto the surface, e.g., vertically or horizontally, for example by spraying 500-1000 L dispersion prepared as described herein per 1000 m², e.g., by using a 500 liter tank pump carried by a vehicle. Thereby, application of 25 to 150 kg, e.g., 25 to 125 kg, 25 to 100 kg, preferably 50-100 kg magnesium compounds (e.g., magnesium oxide) per one dunam (about 1000 m²) surface unit is effective.

The methods as herein defined may optionally further comprise additional steps, prior or further to the application of the MgO powder or suspension/dispersion of the present disclosure, for example applying a biocide (e.g., phenols, aldehydes, etc.) before, after or concomitantly with the application of the suspension/dispersion as herein defined.

The MgO powder or aqueous dispersion(s) of the present disclosure are applied to the target surface as herein defined prior to housing animals into the facility, e.g., 1-7 days before housing. In some embodiments, the aqueous dispersion as herein defined is sprayed onto the surface at time periods where the animals are not in the treated space (namely, the facilities or equipment for management of the animals), subsequent to cleaning the surface.

Thus, regardless of the method used for applying the magnesia compounds or the dispersion(s) comprising the same of the present disclosure, application is performed after the facilities and equipment for management of animals as herein defined have been thoroughly cleaned, preferably no later than 1 to 7 days after cleaning. The surface, also referred to herein as “target surface”, e.g., floors and walls, is therefore preferably subjected to preliminary, thorough cleaning and maintenance steps well known to a skilled artisan, e.g., for the removal of organic material, the presence of which may constitute a basis for pathogen growth. In the case of poultry farming facilities, cleaning is performed after all animals are removed from the facilities to be cleaned, normally between batches. By a non-limiting example, cleaning steps of target surfaces (also termed treated surfaces) in poultry farming facilities include, inter alia, physical removal of any organic material (e.g., litter, dust, manure, blood, feed, carcasses, etc.) by dry cleaning, for example by sweeping or blowing the entire space of the facility, and by wet cleaning, involving a few steps as known in the art. For example, wet cleaning includes soaking with water, washing with water and optionally with the aid of a detergent and rinsing, preferably using a pressure washer to ensure all organic materials are removed from the facilities.

The detergent is, for example, a neutral detergent with a pH between 6 and 8, an alkaline detergent with a pH above 8, etc. A mild alkali which may be used is baking soda (sodium bicarbonate) and moderate alkalis include household ammonia, sodium carbonate, borax and trisodium phosphate. Strong alkalis include, for example, lye (caustic soda). The water used for mixing with the detergent is preferably heated to above 70° C.

Following the wet cleaning step, thorough drying of the surface as herein defined should be performed, e.g., by air-drying or by using a blower or fan, since excess moisture can result in bacteria multiplying to higher levels than seen before cleaning. Additional steps include sealing or repairing of cracks in the building structure using a filling material.

The surface being targeted or treated by the magnesia compounds or aqueous dispersion(s) comprising the same of the present disclosure is any surface susceptible to contamination by at least one microorganism affecting animals raised for food or which is typical to the types of animals being raised. The methods and dispersions of the present disclosure are applicable to any surface that comes in direct or indirect contact with the animals or with any part thereof. Indirect contact with the animals results, for example, from contacting a surface with an object, substance, medium or another surface in direct contact with the animals. The term surface as used herein relates to surfaces located in an animal farming facility, in a vehicle or in a vessel used for transporting the animal, namely, in spaces used for housing, feeding, processing, storage, distributing or transporting such animals, such as abattoirs, hatcheries, foodstuff storage facilities, food preparation and processing facilities, etc. The surfaces of the present disclosure are concrete surfaces, land, soil, ceramic, stone, wood, or metal surfaces. In various specific embodiments the surface being treated is ground, concrete, metal or wood surface. In particular, the surface as herein defined is not textile-based.

By the term “animals raised for food” it is referred to animals to be used as food products or for the preparation of food products, for example animals grown in industrialized farms, by intensive animal farming, or by animal production systems.

By way of example, the animals raised for food (i.e., the animals grown or raised by intensive animal farming) are poultry and the methods and suspensions/dispersions of the present disclosure are applicable to at least one surface located in facilities and on equipment for management of poultry, namely in poultry enclosures or buildings used for poultry growth or housing, also referred to as coops, e.g., commercial chicken or turkey coops, or a vehicle or a vessel used for transporting the poultry. The surfaces may be vertical or horizontal surfaces (i.e., ground, floor, land, walls and ceilings). Therefore the surfaces as herein defined include but are not limited to floors, windows and window sills, ceilings, walls, etc.

For example, the animals raised for food (or animals raised by intensive animal farming) encompassed by the present disclosure include poultry (namely domesticated birds), such as chickens, for example Gallus gallus domesticus, ducks, quails, turkeys, etc., and other livestock, e.g., cattle, sheep, goats, rabbits and pigs as well as camels and horses.

The methods and suspensions/dispersions of the present disclosure are applicable to surfaces susceptible to contamination by any microorganism affecting animals raised for food (or animals raised by intensive animal farming), namely any microorganism considered to be a disease-causing agent in domesticated animals raised in an agricultural setting for consumption, free-range or intensive farming (e.g., indoor production), whether the disease is symptomatic or not in the affected animal. In any case, the methods and suspensions/dispersions of the present disclosure are suitable, among others, to microorganism species which are considered to be disease causing agents (or pathogenic) in humans while not causing a disease in animals.

In some embodiments the microorganism as herein defined is a bacterial microorganism (also termed herein “agent”). Some non-limiting particular examples of bacterial microorganisms according to the preset disclosure are Salmonella sp., Listeria sp., E. coli, Campilobacter and Staphylococcus aureus. In particular embodiments, the bacterial microorganism as herein defined is at least one gram-negative bacteria. In particular, the bacterial microorganism according to the present disclosure is at least one species of the family Enterobacteriaceae, for example at least one Salmonella spp.

In other embodiments the microorganism as herein defined is a viral microorganism (agent), e.g., the viral microorganism is at least one avian virus, for example, a species of the Orthomyxoviridae family, such as avian Influenza virus, a species of the Paramyxoviridae family, a species of the Birnaviridae family or a species of the Caliciviridae family. Some non-limiting examples of viral microorganisms, are avian influenza A viruses (e.g., of the serotype H5N1 or H2N6), and murine Norovirus (MNV).

As detailed above, the present disclosure is particularly useful in preventing microorganism contamination of a surface or decontamination of a surface located in facilities and on equipment for management of poultry, namely domesticated birds kept by humans for their eggs, meat or their feathers, in particular when grown in intensive animal farming (or intensive systems), for example but not limited to turkeys. Poultry are known to be affected by a plethora of disease-causing agents, among which are bacterial agents such as Salmonella sp. and Campilobacter Spp., as well as viral agents such as those causing avian influenza (also termed “avian flu”), to name but a few. As shown in the Examples below, the inventors have shown that disinfection of poultry farmhouses (turkey coops) by spraying a dispersion comprising MgO on the surfaces of the growth facilities was effective against Salmonella, as evidenced by a substantial reduction of Salmonella concentration below the detection limit. Therefore, the present disclosure is particularly applicable for preventing microorganism contamination of a surface or decontaminating a surface located in facilities and on equipment for management of poultry by at least one Salmonella species, serotype or any subspecies thereof.

Salmonella (also referred to herein Salmonella spp., namely, any species of Salmonella) is a highly diverse genus of Gram-negative bacterial species and sub-species, which overall contain about 2600 different serotypes (also termed “serovars”). Salmonella spp. as known to a skilled person, is a worldwide foodborne pathogen and the second leading disease-causing agent for gastrointestinal human infections after Campilobacter Spp. Serovars are characterized and classified, inter alia, by their antigenic character, host specificity or by their clinical outcome, ranging from asymptomatic carriage to invasive systemic disease and even death. For example, the species Salmonella enterica is further divided into sub-species, among which is Salmonella enterica subspecies enterica which encompasses over 1000 serovars, including Salmonella typhimurium and Salmonella enteritidis principally responsible for human infection along with S. infantis, S. stanley and S. newport. In particular, in Europe, the two Salmonella serovars that are specifically regulated in laying flocks in all Member States are Enteritidis and Typhimurium (EC, 2003). Serovars may also be classified by assigning into serovar groups, such as group B (including, e.g., Salmonella typhimurium and Salmonella stanley), group C which is further classified as group C1 (including, e.g., Salmonella infantis and Salmonella paratyphi) and group C2 (including, e.g., Salmonella newport), group D (including, e.g., Salmonella enteritidis), group E (including, e.g., Salmonella liverpool), group G (including, e.g., Salmonella cubana), etc.

Therefore, by way of example, the methods as herein defined are suitable for preventing contamination of a surface as herein defined or decontaminating such surface by at least one Salmonella species or serovar, e.g., by Salmonella typhimurium, Salmonella enteritidis or species of Salmonella group B or any combination thereof.

In other words, the present disclosure provides a method for preventing microorganism contamination of a surface, or decontaminating a surface, comprising applying magnesia (MgO) onto said surface, wherein the surface is located in facilities and on equipment for management of animals raised for food, such as animals raised by intensive animal farming, the magnesia is applied in the form of an aqueous dispersion comprising MgO at not less than 5% by weight based on the total weight of the aqueous dispersion, and wherein the dispersion optionally comprises at least one suspension aid, further wherein the animals are poultry, and the surface is located in a poultry farming or intensive farming facility, a vehicle or a vessel used for transporting the poultry and wherein said microorganism is Salmonella spp.

Thus the present disclosure provides a method for preventing Salmonella spp. contamination of a surface located in a poultry farming (or intensive farming) facility, a vehicle or a vessel used for transporting the poultry, or decontaminating said surface, comprising applying an aqueous dispersion comprising MgO at not less than 5% by weight based on the total weight of the aqueous dispersion, wherein said aqueous dispersion optionally comprises at least one suspension aid.

As detailed herein, magnesia dispersions may also be effective against viral pathogens common with poultry farming as evidenced by the virus inactivation effect demonstrated in cells infected by various viral species.

Avian influenza, also known as “bird flu” or “avian flu”, is a disease primarily affecting birds and is caused by a virus of the Orthomyxoviridae family. The virus may be classified inter alia as having high or low pathogenicity, presenting different symptoms in infected birds. While Low Pathogenic Avian Influenza Virus (LPAIV) can cause a mild illness, the Highly Pathogenic Avian Influenza Virus (HPAIV) caused by subtypes (H5 and H7) of type A causes serious illness in birds that can spread rapidly, resulting in high death rates in different species of birds.

Therefore, the present disclosure further provides a method for preventing contamination by at least one avian influenza virus of a surface located in a poultry farming facility, a vehicle or a vessel used for transporting the poultry, or decontaminating said surface, comprising applying an aqueous dispersion comprising MgO at not less than 5% by weight based on the total weight of the aqueous dispersion, wherein said aqueous dispersion optionally comprises at least one suspension aid.

Poultry meat and eggs are the most common source of human infection, highlighting the importance of careful and periodic cleaning and disinfection procedures and contamination evaluation of the food chain associated with commercial production.

By the term “microorganism contamination” it is referred to a microorganism culture (e.g., bacteria, viruses or fungi) at a concentration above the maximum concentration of that microorganism recommended by known standards relating to food supply chains. By the term “preventing microorganism contamination of a surface or decontaminating a surface” it is meant to preclude, inhibit or at least reduce the concentration of the contaminating microorganism, e.g., below the recommended limit or at least by the recommended limit of microorganisms as defined by known standards relating to food supply chains.

Evaluation of the efficacy of the methods for preventing contamination/decontamination as defined herein, e.g., evaluation of the microbiological status of poultry houses, may be performed according to any practice known to a skilled artisan, e.g., according to specific international or national standards and regulations suitable for the microorganism contaminant at question. Evaluation methods include direct and indirect methods, where direct methods include examining surfaces associated with growing, storage and/or transportation of e.g., poultry or eggs for the presence of for example contaminating bacteria or virus, by obtaining a sample thereof and quantitatively analyzing the amount of bacteria or viral agents residing in the sample. Indirect methods include examining the weight gain of the animals (e.g., poultry), mortality percentage and various other observations characterizing the suspected disease.

Many different types of samples may be used for evaluating the microbiological status of houses or buildings used for animal farming (e.g., poultry houses), including feces and environmental samples such as litter, and dust, to name but a few. Samples are collected periodically (e.g., 1-10 times per year, for example twice during animal growing cycle, for example every four months or at least three times per year) and in particular, 1-10 days after applying the dispersion(s)/suspension(s) of the present disclosure and periodically (e.g., every 3-5 weeks) thereafter. Environmental samples are then analyzed for the specific relevant microorganism by ways known in the art.

For example, methods for detection of bacterial or viral agents, e.g., Salmonella spp. or avian influenza virus, in food, in animal feed, in animal feces and in environmental samples obtained from the production or handling stage of the food or animals are well known in the art.

The method for detection of Salmonella spp. can follow international standards which generally include the following steps. First, environmental samples (or specimens) of at least one of feces and dust are collected using sterile collecting devices and assembled in sterile containers (e.g., tube, spatula, swab, etc.). Samples collected in containers are generally of about 100-200 gr, e.g., 150 gr. Samples are collected from ample representative locations in the buildings, e.g., from between 50-100 different locations, such as 60 locations. For example, dust samples assembled into containers are collected from fans, beams, furniture and from under the cages. Swab dust samples (using, e.g., four different swabs soaked in powdered milk, each sweeping across an area of a square meter) are collected from at least one of walls, nets, coops (cages), fans and feeding troughs. Dust samples collected by drag swabs soaked with powdered milk are dragged for about 5-10 minutes on the building floor by the sampler, two drag swabs per area of the building (e.g., per one fifth, quarter, third or half of the building), and assembled into a sterile container (e.g., plastic bag). Furthermore, dust samples collected by drag swabs at handling areas (e.g., egg storage or sorting rooms) are collected, e.g., by five pairs of drag swabs sweeping over the entire area of the facility and marked according to the sampling area.

The samples or specimens are analyzed for the presence of Salmonella spp. according to methods known to a skilled artisan, for example, according to ISO 6579-1:2017. Briefly, the procedure for detection of Salmonella in animal feces and in environmental samples obtained from the growth facilities generally includes the steps of pre-enrichment, selective enrichment, plating-out and confirmation. The pre-enrichment step includes ten-fold dilution of the sample into buffered peptone water (BPW) and incubating for 18±2 hours at 34-38° C. The selective enrichment step includes plating 0.1 ml of the pre-enrichment culture (three drops in three different spots) onto modified semi-solid Rappaport-Vassiliadis (MSRV) Agar which is a medium used for the selective enrichment of motile Salmonellae in animal feces and environmental samples, containing, among others, enzymatic digest of animal and plant tissue, acid hydrolysate of Cascin, various salts, novobiocin antibiotics (mostly active against Gram-positive bacteria) and agar as a solidifying agent. The plates are then incubated for 24±3 hours at 41.5±1° C. A grey-white turbid zone extending out from the inoculated drop indicates a positive result for motile Salmonella spp. Negative plates, where the medium remains blue green around inoculation drops, should be re-incubated for a further 18-24 hours. The plating-out step includes plating (sub-culturing) the resulting (positive) colonies on Xylose Lysine Deoxycholate agar (XLD agar, which is a selective growth medium used in the isolation of gut bacteria), with the inoculum being taken from the furthest edge of the migration zone. The plates are incubated for 24±3 hours at 37±1° C. Positive colonies obtained on the MSRV plates are plated on an additional (second) isolation agar (e.g., Chromatic Salmonella). This step provides presumptive identification and characteristic presumptive Salmonella colonies are confirmed with a confirmation step, which includes testing of at least one typical suspected colony (if negative, an additional four colonies are tested) by first plating on non-selective agar and incubating for 24±3 hours at 34-38° C. and conducting a biochemical test (using the triple sugar-iron agar (TSI) test designed to differentiate among Salmonella species based on differences in carbohydrate fermentation patterns and hydrogen sulfide production; TSI agar contains carbohydrates such as glucose, lactose and sucrose) and a serological test performed on colonies showing biochemical reactions typical for Salmonella, which includes determining the presence of Salmonella specific antigens (e.g., Salmonella O and H-antigens) using polyvalent antisera.

The invention will be further described and illustrated by the following examples.

### EXAMPLES

Materials used are listed in Table 1 below.

TABLE 1
Materials

| COMPONENT | | |
|---|---|---|
| (MANUFACTURER) | GENERAL DESCRIPTION | FUNCTION |
| Pyrophosphate | Pyrophosphate dispersant | Dispersant |
| dispersant | | |
| (Jost Chemicals) | | |
| Magnesium Oxide | Magnesium oxide | Active agent |
| (ICL-IP) | | |
| Mg(OH)₂ (ICL-IP) | Magnesium hydroxide | Active agent |
| Basic Magnesium | Basic magnesium carbonate | Active agent |
| carbonate (ICL-IP) | | |
| Glutamon (BIOVAC) | A standard disinfectant, | Active agent |
| | a combination of | |
| | glutaraldehyde and | |
| | quaternary ammonium | |
| | salts | |
| Chlorigal T (BIOVAC) | Chloramine T | Active agent |
| | trihydrate, a standard | |
| | disinfectant, Sodium | |
| | N-chloro-para- | |
| | toluenesulfonamide | |

### Methods

Examining the effect of magnesium compounds on Salmonella typhimurium cultures The effect of MgO, Mg(OH)₂ and MgCO₃·Mg(OH)₂ (basic magnesium carbonate) on the viability of the Salmonella species S. typhimurium was tested as follows. First, S. typhimurium cultures (2.4·10⁴) were prepared and diluted 100, 1000, 10,000 and 100,000-fold into sterile tubes (20 ml) containing aqueous suspensions of MgO, Mg(OH)₂ or Mg(HCO₃)₂ at 1%, 2% or 3%. The diluted S. typhimurium cultures were then incubated for 24 hours at 37° C., while shaking. Then, samples thereof (2 ml) were plated on sterile plates and incubated over-night at 37° C. The number of (visible) colonies grown on the plates was then counted. Aqueous suspensions of MgO were prepared as detailed for Preparation 1 below. Aqueous suspensions of Mg(OH)₂ and Mg(HCO₃)₂ at the indicated concentrations were prepared by adding Mg(OH)₂ or Mg(HCO₃)₂ powder to water, to obtain the desired final concentrations of the magnesium compounds in the suspension. The suspensions were mixed by high shear mixing.

### Cleaning of Poultry Buildings

Poultry (turkey) buildings (also termed coops) were thoroughly and carefully cleaned prior to the disinfecting step, by dry cleaning (e.g., by sweeping) and by wet cleaning, e.g., by rinsing the floors with a water hose. Cleaning further included using alkaline soap to clean the surfaces from organic residue as well as thorough wash with water.

### Application of Disinfectants in Poultry Facilities (Hygiene Process)

Dispersions comprising MgO (10% or 20% weight per total weight of the dispersions) and a pyrophosphate dispersant (2.5% weight per total weight of MgO) prepared as detailed in Preparation 2 below, a dispersion comprising Glutamon (1%) prepared as detailed in Preparation 3 below, or a dispersion comprising Chlorigal T (1%) prepared as detailed in Preparation 4 below were sprayed (each) using a small motor vehicle equipped with a 500 liter tank piped to a centrifugal pump, through special nozzles onto clean, empty poultry (turkey) building surfaces, at a rate of 500 liter per 1000 m² (about one dunam). Disinfection was applied 1-2 days after cleaning.

### Collecting Environmental Specimens Using Drag Swabs

Environmental samples were collected from poultry buildings that were treated by spraying of a dispersion comprising MgO and a pyrophosphate dispersant (in which MgO was at 10% or 20%) as well as from poultry buildings treated by spraying of a dispersion comprising a standard disinfectant (i.e., Glutamon at 1% or Chlorigal T at 1%), one week after the application of the dispersions, by the drag swab method, as follows.

Swabs (gauzes soaked with powdered milk, connected to a string) were used for collecting the environmental specimens. The building floor was divided into two areas, and each area was sampled by dragging a separate swab onto the floor, for five minutes. The swabs were placed into the plastic bags marked with the designation of the building and maintained under refrigeration (4-15° C.) until analysis, which was conducted on the same day.

### Specimen Analysis

Detection of Salmonella in environmental samples (swabs) obtained from the poultry growth facilities treated as detailed above generally included the steps of pre-enrichment, selective enrichment, plating-out and confirmation, following the requirements set forth by the International Organization for Standardization in ISO 6579-1:2017.

### Preparation 1

### Aqueous Dispersion of Magnesium Oxide (MgO)

### (A) Preparation of Magnesium Oxide

Magnesium Oxide was prepared as follows. Magnesium chloride (MgCl₂) solution at a concentration of 400-550 gr/l was roasted at a high temperature in a reactor (700-850° C.). Magnesium chloride was thereby decomposed to magnesium oxide (MgO) and hydrochloric acid (HCl). Magnesium oxide (MgO) was hydrated to magnesium hydroxide (Mg(OH)₂) at a temperature of 60-90° C. Magnesium hydroxide was washed from soluble salts and milled to the required particle size, and then fed to a high temperature (600 to 950° C.) kiln where magnesium hydroxide was decomposed to magnesium oxide and water. The magnesium oxide obtained according to the process described above was then milled in a dry milling system (Jet Mill or pin mill) operated within the range of between 2 and 4.5 atmospheres of dry air pressure and powder flow rate between 100 to 200 kg/hr. The milling machine “Jet Mill” was kept under slightly negative pressure (very close to zero pressure) in order to control particle size distribution, Loss on Ignition (LOI) and surface area. Analytical results obtained for a MgO sample so obtained are provided in Table 2 below.

TABLE 2
Analytical results of MgO sample

| | | | Typical |
|---|---|---|---|
| Test | Units | Specification | result |
| Assay as Magnesium oxide, MgO | % | 96-100.5 | 99.7 |
| Free Alkali | ml | 2.0 max | 0.54 |
| Acid insoluble HAc | % | 0.1 max | 0.038 |
| Soluble Salts/Substances | mg | 2.0 max | 1.5 |
| Chlorides as Cl | % | 0.1 max | 0.04 |
| Arsenic as As ICP | ppm | 1.5 max | 0.6 |
| Calcium as CaO | % | 1.0 max | 0.06 |
| Iron as Fe | ppm | 700 max | 37 |
| Loss on Ignition | % | 4.0 max | 0.6 |
| Lead as Pb ICP | ppm | 0.5 max | 0.4 |
| Bulk Density (untapped) | g/cc | 0.25 min | 0.32 |
| Particle Size: residue on | % | 1.0 max | 0.1 |
| 325 mesh (wet sieve) | | | |
| Particle Size: residue on | % | 0 | 0 |
| 100 mesh (wet sieve) | | | |

The MgO prepared as described above is characterized by a d₁₀ lower than 1.5 microns (namely 10% of the particles are smaller than this size), by a d₅₀ ranging from 1.5 to 6.0 microns (namely 50% of the particles are smaller than this size), by a d₉₀ ranging from 8.0 to 45 microns (namely 90% of the particles are smaller than this size), by specific BET surface area above 5.0 m²/gr, by a citric acid activity (CAA 40) ranging from 25 to 200 seconds, by a Loss on Ignition (LOI) ranging from 0.2 to 4.0%, and by a bulk density (untapped) of not less than 0.25 gr/ml.

### (B) Dispersion of Magnesium Oxide in Water

Magnesium oxide (500 gr) was suspended in 9.5 kg water (tap, drinking water) using a high shear mixer (ULTRA-TURRAX T50, JANKE & KUNKEL, IKA-Labortechnik) to obtain a homogenous suspension of 5% MgO (all concentrations reported herein are by weight relative to the total weight of the suspension/dispersion unless indicated otherwise). Homogenous suspensions of 1%, 2% or 3% MgO were prepared by further dilution in water.

### Preparation 2

### Aqueous Dispersions of MgO and a Pyrophosphate Dispersant

Dispersions comprising magnesium oxide, and a pyrophosphate dispersant as a suspension aid (dispersant) were prepared by adding the suspension aid to the magnesium oxide powder first and mixing well, the mixed powder was then added to water, to obtain the desired final concentrations of magnesium oxide and suspension aid (dispersant) in the suspension. The suspension was mixed by high shear mixing, as detailed above.

Specifically, for preparing homogenous suspensions comprising MgO at 10% or 20% by weight of the total weight of the dispersion and a pyrophosphate dispersant at 2.5% by weight of the total weight of the magnesium compounds, a pyrophosphate dispersant (1.25 kg or 2.5 kg) was added to MgO powder (50 kg or 100 kg, respectively), mixed and then added to water such that a total volume of 500 L was obtained, in a high shear mixer.

### Preparation 3

### Aqueous Dispersions of 1% Solution of Glutamon

An aqueous dispersion (500 L) of Glutamon (a combination of glutaraldehyde and quaternary ammonium salts) at 1% weight by the total weight of the dispersion was prepared according to the manufacturer's instructions.

### Preparation 4

### Aqueous Dispersions of 1% Chlorigal T

The dispersion was prepared according to the manufacturer's instructions, by dispersing Chlorigal T at 10 gram per liter (1%).

### EXAMPLE 1

### Side by Side Analysis of the Effect of Mg(OH)₂, MgO and Basic Magnesium Carbonate (BMC) on the Viability of Salmonella typhimurium in Culture

S. typhimurium cultures were treated by dispersions comprising 1, 2 or 3% Mg(OH)₂, MgO or BMC as described above. The results, showing 100-fold diluted S. typhimurium cultures incubated with dispersions comprising Mg(OH)₂, MgO or BMC at the indicated concentrations, are listed in Table 3 below. As shown in Table 3, while at least about 100 colony forming units (CFU) were obtained in each one of the bacteria plates treated with either Mg(OH)₂ or BMC dispersions, MgO dispersions at all tested concentrations effectively reduced the viability of S. typhimurium to below the detection level (<1).

TABLE 3
Salmonella colony forming units (CFU) in the presence of dispersions
comprising Mg(OH)₂, MgO or BMC at various concentrations

| Magnesium compound | Mg(OH)₂ | MgO | BMC |
|---|---|---|---|
| conc. | (CFU) | (CFU) | (CFU) |
| 1% | 130, 140 | <1 | 172, 180 |
| 2% | 120, 140 | <1 | 106, 120 |
| 3% | 85, 70 | <1 | 120, 115 |

### EXAMPLE 2

### The effect of Spraying a Dispersion Comprising 10% or 20% MgO on the Presence of Salmonella in a Poultry Farming Building as Compared to the Effect of a Standard Disinfectant

Further to the results demonstrated above on Salmonella cultures, the decontaminating effect of a dispersion comprising MgO was examined in poultry buildings, separately treated with aqueous dispersions comprising 10% or 20% MgO (by weight of the total weight of the dispersion) and a pyrophosphate dispersant (at 2.5% by weight of the total weight of the magnesium compounds). The dispersions were prepared as detailed in Preparation 2, above. The dispersions were applied to empty poultry buildings, after the buildings were cleaned, by spraying, as described above. In parallel, similar poultry buildings were sprayed with a solution comprising a standard disinfectant (Glutamon, at 1%), prepared as detailed in Preparation 3 above, in the same manner.

The buildings treated with MgO dispersions as well as the buildings treated with the Glutamon standard disinfectant were then evaluated for the presence of Salmonella species, by obtaining two separate swab samples from each one of the buildings (Sample “#1” and Sample “#2” in Table 4 below) covering the entire area of the building and analyzing thereof one week after the dispersions were applied. Collecting the samples and their analysis were performed as detailed above. The experiments performed with the dispersions comprising MgO at 10% and 20% were termed “Experiment 1” and “Experiment 2”, respectively.

As demonstrated in Table 4 below, the effect of the MgO dispersion at 10% MgO (Experiment 1) was comparable to the effect of the Glutamon standard disinfectant, where the standard disinfectant was able to inhibit all Salmonella groups other than Group C and the MgO dispersion was able to inhibit all Salmonella groups other than Group C or Group G. While the results are comparable, use of MgO dispersions is advantageous since they are considered to be environmentally friendly and not harmful to animals and humans.

Furthermore, the dispersion comprising MgO at 20% (Experiment 2) was more effective than the standard disinfectant, in view of the negative results obtained by application thereof, indicating that all Salmonella groups were inhibited, compared to the results obtained for the Glutamon standard disinfectant.

TABLE 4
Salmonella test results one week after application of MgO at 10% or
20% vs a standard disinfectant

| Experiment | Agent used | Sample #1 | Sample #2 |
|---|---|---|---|
| 1 | Standard disinfectant | Group C | Group C |
| 1 | MgO (10%) | Group C | Group G |
| 2 | Standard disinfectant | Group G | Group G |
| 2 | MgO (20%) | Negative | Negative |

### EXAMPLE 3

### Comparing the Effect of Spraying Dispersions Comprising MgO at 20% to the Effect of Standard Disinfectants on the Presence of Salmonella in Poultry Farming Buildings

Further to the results presented in Example 2 above, the decontaminating effect of dispersions comprising MgO was examined in poultry buildings and compared to that of a further standard disinfectant, namely Chlorigal T.

As described in connection with Example 2 above, poultry housing buildings were treated either with aqueous dispersions comprising 20% MgO (by weight of the total weight of the dispersion) and a pyrophosphate dispersant (at 2.5% by weight of the total weight of the magnesium compounds) prepared as detailed in Preparation 2 above, with a solution comprising the standard disinfectant Glutamon (1%) prepared as detailed in Preparation 3 above, or with a solution comprising the chlorine-based standard disinfectant (Chlorigal T, 1%) prepared as detailed in Preparation 4 above.

In all cases, the agents were applied by spraying empty poultry buildings, after the buildings were cleaned, as described above. The presence of Salmonella species was evaluated one week after application of the agents, by obtaining and analyzing as described above two separate swab samples from each one of the treated buildings (Sample “#1” and Sample “#2” in Table 5).

Table 5 reports the results of three experiments (field tests) performed in poultry buildings. All of the field tests were conducted using a dispersion comprising MgO at 20%. In the first test (Experiment 3) the effect of the MgO dispersion was compared to the effect of Chlorigal T and in the other tests (Experiments 4 and 5) the effect of the MgO dispersion was compared to that of Glutamon.

As demonstrated in the results of Experiments 3 and 5 in Table 5 below, the effect of the MgO dispersion was comparable to the effect of each one of the standard disinfectants used as reference, controlling all the tested Salmonella groups. While the results are comparable, use of MgO dispersions is advantageous since they are considered to be environmentally friendly and not harmful to animals and humans, as mentioned above. Furthermore, the results of Experiment 4 indicate that the effect of the MgO dispersion was superior to the effect of Glutamon, in the presence of which Salmonella group B was detected.

It is also reported that two separate samples were obtained from empty poultry buildings after the buildings were cleaned, but before applying any one of the agents. Analysis of these samples (conducted as described above) indicated the presence of a mixture of two Salmonella groups, B and G.

TABLE 5
Salmonella test results one week after application of MgO at 20% vs
standard disinfectants

| Experiment | Agent used | Sample #1 | Sample #2 |
|---|---|---|---|
| 3 | Standard disinfectant (Chlorigal T) | Negative | Negative |
| | MgO (20%) | Negative | Negative |
| 4 | Standard disinfectant (Glutamon) | Group B | Group B |
| | MgO (20%) | Negative | Negative |
| 5 | Standard disinfectant (Glutamon) | Negative | Negative |
| | MgO (20%) | Negative | Negative |

Taken together, the results show that application of MgO dispersions containing 20% MgO is effective in inhibiting growth of the bacteria.

### EXAMPLE 4

### The Virucidal Effect of MgO Dispersion

In order to evaluate the virucidal activity of MgO in dispersion (comprising 5% MgO and prepared as described above for Preparation 1) against avian influenza virus A (H5N1 and H2N6) and against Norovirus, an in vitro study was conducted, generally based on a standard procedure (using the test kit BS EN 14476:2013+A2:2019, Chemical disinfectants and antiseptics. Quantitative suspension test for the evaluation of virucidal activity in the medical area. Test method and requirements (Phase 2/Step 1)).

SPF-Embryonating chicken eggs (obtained from the Vaxxinova-Biovet Laboratory, University of Campinas—São Paulo/Brazil) were used as hosts for the viral agents avian influenza A virus (H5N1) and avian influenza virus A (H2N6), and RAW 264.7 cells (ATCC catalog no. TIB-71) were used as hosts for Murine norovirus (MNV) (ATCC VR-1937™). Cells and eggs were maintained and handled according to acceptable procedures.

The results shown in Table 6 below are expressed as percentage of viral inactivation in comparison with untreated viral control, where “one” (1) reduction log means a reduction factor (RF) of 10 and reduction percentage/inactivation of 90%, two (2) reduction logs mean a reduction factor (RF) of 100 and reduction percentage/inactivation of 99%, three (3) reduction logs mean a reduction factor (RF) of 1000 and reduction percentage/inactivation of 99.9%, four (4) reduction logs mean a reduction factor (RF) of 10,000 and reduction percentage/inactivation of 99.99%, five (5) reduction logs mean a reduction factor (RF) of 100,000 and reduction percentage/inactivation of 99.999%, and six (6) reduction logs mean a reduction factor (RF) of 1,000,000 and reduction percentage/inactivation of 99.9999%, as known in the field.

TABLE 6
Viral infectivity reduction factor (RF) of a dispersion comprising
MgO (at 5% ) over time, tested in vitro

| Contact | H5N1* | H2N6* | Norovirus |
|---|---|---|---|
| time | viral titer: | viral titer: | viral titer: |
| (hours) | 1.10⁶ EID₅₀/ml | 1.10^{5.5} EID₅₀/ml | 1.10⁸ TCID₅₀/ml |
| 2 | 4 | 4 | 5 |
| 5 | 5 | 5 | 5 |
| 12 | 5 | 5 | 6 |
| 24 | 5 | 5 | 6 |

*Results are shown as viral infectivity reduction factor (RF) EID₅₀/mL.

**Results are shown as viral infectivity reduction factor (RF) TCID₅₀/mL.

Abbreviations: EID₅₀/mL, 50% egg infective dose per ml; TCID₅₀/mL, tissue culture infectious dose, dilution of a virus required to infect 50% of a given cell culture per ml.

Reduction factor (RF) for the avian viruses was calculated as follows: RF=TV−TT (where TV means Untreated virus titer and TT means Treated test virus titer) calculated in EID₅₀/mL, Mean of virus dilutions (from 1·10¹ to 1·10⁸) in 4 replicates. Reduction factor (RF) for the Norovirus was calculated as follows: RF=TV−TT calculated in TCID₅₀/mL, Mean of virus dilutions (from 1·10¹ to 1·10¹⁰) in 4 replicates.

As shown in Table 6, a dispersion comprising MgO at 5% showed a virucidal activity against three different viruses (enveloped and non-enveloped), showing inactivation activity against Avian Influenza A virus (H5N1 and H2N6), of 99.99% to 99.999% (i.e., 4-5 log reduction), and for Norovirus (non-enveloped) the dispersion showed a very good inactivation activity. from 99.999% to 99.9999% (i.e., 5-6 log reduction).

1. A method for preventing microorganism contamination of a surface, or decontaminating a surface, comprising applying magnesia (MgO) onto said surface, wherein the surface is located in facilities and on equipment for management of animals raised for food.

2. The method according to claim 1, wherein the magnesia is applied in the form of an aqueous dispersion which optionally comprises at least one suspension aid.

3. The method according to claim 2, wherein said aqueous dispersion comprises MgO at not less than 5% by weight based on the total weight of the aqueous dispersion.

4. The method according to any one of claims 1 to 3, wherein said surface is located in an animal farming facility, a vehicle or a vessel used for transporting the animal.

5. The method according to any one of claims 1 to 4, wherein the animals are poultry, and the surface is located in a poultry farming facility, a vehicle or a vessel used for transporting the poultry.

6. The method according to any one of claims 1 to 5, wherein said microorganism is a bacterial microorganism.

7. The method according to any one of claims 1 to 6, wherein said microorganism is Salmonella spp.

8. The method according to any one of claims 1 to 5, wherein said microorganism is a viral microorganism.

9. The method according to claim 8, wherein said viral microorganism is Avian influenza virus or Norovirus.

10. The method according to any one of claims 1 to 9, wherein said magnesia compound (MgO) is characterized by having a particle size distribution with d₁₀ ranging from 0.5 μm to 1.5 μm, d₅₀ ranging from 1.5 μm to 6.0 μm and d₉₀ ranging from 5.0 um to 45.0 μm, wherein said magnesia compound is further characterized by having:
a) a surface area ranging from 5.0 to 25.0 m²/gr,
b) a citric acid activity (CAA 40) ranging from 25 to 300 seconds,
c) a loss on ignition (LOI) ranging from 0.1% to 8.0% by weight, and
d) a bulk density ranging from 0.25 to 0.60 gr/ml.

11. The method according to any one of claims 1 to 10, wherein the aqueous dispersion is sprayed onto said surface at time periods where the animals are not in the treated space, subsequent to cleaning the surface.

12. A method according to claim 1 for preventing Salmonella spp. contamination of a surface located in a poultry farming facility, a vehicle or a vessel used for transporting the poultry, or decontaminating said surface, comprising applying an aqueous dispersion comprising MgO at not less than 5% by weight based on the total weight of the aqueous dispersion, wherein said aqueous dispersion optionally comprises at least one suspension aid.

13. The method according to any one of the preceding claims, provided that said surface treated is ground, concrete, metal or wood surface.

14. The method according to any one of the preceding claims, wherein said animals raised for food are animals raised in intensive animal farming.
